(19) United States
(12) Patent Application Publication
(10) Pub. No.: US 2007/0178829 A1
(43) Pub. Date: Aug. 2, 2007

(54) Broadcast signal receiving system

(75) Inventor: Masanobu Tanaka, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/655,839

(22) Filed: Jan. 22, 2007

(30) Foreign Application Priority Data
Jan. 20, 2006 (JP) 2006-012088

(51) Int. Cl. H04H 7/00; H04B 3/36; H04B 7/14

(52) U.S. Cl. 455/3.06; 455/7

(57) ABSTRACT

Disclosed is a broadcast signal receiving system including: an antenna, a transmitter connected to the antenna, and a receiver connected to the transmitter in a wireless manner, wherein the transmitter comprises encoding member to encode a broadcast signal which is output from the antenna, modulating member to modulate a wavelength of the broadcast signal encoded by the encoding member, into cm waveband, and a sending section for sending the broadcast signal modulated by the modulating member to the receiver in the wireless manner, the receiver comprises a receiving section for receiving a broadcast signal sent from the transmitter, demodulating member to modulate a broadcast signal received by the receiving section, and decoding member to decode a broadcast signal demodulated by the demodulating member.

### BACKGROUND OF THE INVENTION

1. Field of the Invention

The present invention relates to a broadcast signal receiving system.

2. Description of Related Art

Conventionally, when a broadcast signal received by an antenna is sent to a device in each room, an antenna terminal provided on a wall or the like in the room and each device are connected to each other through a cable, and the broadcast signal from the antenna is sent to each device through the cable. However, when the number of rooms is high or when the number of devices to which it is desired to sent the broadcast signal is high, many cables are connected to the devices, and cleaning operation and maintenance of the room is extremely inconvenient due to the many cables. Hence, there is a known broadcast signal receiving system which converts a broadcast signal received by an antenna into a broadcast signal of millimeter waveband (60 GHz) and sends the same to each device in a wireless manner (e.g. JP2002-111615A).

Further, there is also a known broadcast signal receiving system which distributes a broadcast signal received by an antenna by means of a distributor, sends the distributed broadcast signal to a transmitter disposed in each room through a coaxial cable from the distributor, and sends the broadcast signal to the device in each room through the transmitter in a wireless manner (e.g. JP2000-232462A).

There are also known transmitter which is disposed on a ceiling of a room to send a broadcast signal from an antenna to each device in the room in a wireless manner, an infrared manner, or the like (e.g. JP2001-157080A), and transmitter which amplifies the broadcast signal by an amplifier to send the same in a wireless manner to an inside of a building or the like where a broadcast signal does not easily reach (e.g. JP2004-128720A).

The radio communication is also utilized for a local area network (e.g. JP2002-158687A).

However, the broadcast wave of millimeter waveband described in JP2002-111615A is shut off by a wall or the like and thus, when the number of rooms is high, a broadcast signal can not sufficiently be sent to a device in each room in the actual case. In JP2000-232462A, it is necessary to dispose a coaxial cable in each room from the distributor, and the system itself becomes large in scale. In the transmitter of JP2001-157080A, a broadcast signal can be sent only to a device in the same room. In the transmitter described in JP2004-128720A, since a broadcast signal is amplified as it is, there is a problem that a broadcast signal is leaked to an adjoining house in a stand-alone house or a condominium smaller than a building.

### SUMMARY OF THE INVENTION

It is an object of the present invention to provide a broadcast signal receiving system capable of preventing a broadcast signal from leaking outside of a house, and capable of easily sending a broadcast signal to a device in each room in a wireless manner.

In order to accomplish the above object, in accordance with a first aspect of the invention, a broadcast signal receiving system comprising an antenna, a transmitter connected to the antenna, a receiver connected to the transmitter in a wireless manner, and a broadcast signal receiver connected to the receiver, wherein the transmitter comprises encoding member to encode a broadcast signal which is output from the antenna, modulating member to modulate a wavelength of the broadcast signal encoded by the encoding member, into cm waveband, an adjusting member to set the wavelength of the broadcast signal modulated by the modulating member within the cm waveband, and a sending section for sending the broadcast signal modulated by the modulating member to the receiver in the wireless manner, the receiver comprises a receiving section for receiving a broadcast signal sent from the transmitter, demodulating member to modulate a broadcast signal received by the receiving section, decoding member to decode a broadcast signal demodulated by the demodulating member, and branching member to branch a broadcast signal decoded by the decoding member and to output the same to the broadcast signal receiver, the modulating member modulates a broadcast signal which is encoded by the encoding member into a wavelength which is set by the adjusting member.

According to a first aspect of the present invention, in the transmitter, a broadcast signal which is output from an antenna is encoded by the encoding member, a wavelength of the encoded broadcast signal is modulated into a cm waveband by a modulating member, the modulated broadcast signal is sent to a receiver by a sending section in a wireless manner, the broadcast signal sent from the transmitter is received by a receiving section in the receiver, the broadcast signal is demodulated by the demodulating member, and the demodulated broadcast signal is decoded by a decoding member. Since the broadcast signal sent from the transmitter is modulated into a cm waveband, it is possible to prevent the broadcast signal from leaking to an adjoining house in a small stand-alone house or a condominium, the broadcast signal modulated into a cm waveband is not shut off by a wall or the like and the broadcast signal can be sent to each receiver, and it is possible to prevent a broadcast signal from leaking outside of a house and a broadcast signal can reliably be sent to a device in each room.

Further, since the broadcast signal is sent from the transmitter to the receiver in the wireless manner, it is unnecessary to connect an antenna terminal and each device through a cable, and a broadcast signal can easily be sent to a device in each room in the wireless manner.

A broadcast signal decoded by the decoding member is branched by branching member and is output to the broadcast signal receiver. Therefore, even if a broadcast signal sent from the transmitter is mixed with an FM signal, an AM signal, a ground digital signal, a BS/CS signal, a ground analogue signal or the like, the broadcast signal can be branched into a broadcast signal necessary for each broadcast signal receiver.

Since the modulating member modulates a broadcast signal encoded by the encoding member into a wavelength which is set by adjusting member, a wavelength of a broadcast signal to be modulated can be adjusted in accordance with a range where the broadcast signal is sent, it is possible to prevent a broadcast signal from leaking outside of a house more reliably, and a broadcast signal can be sent to a device in each room more reliably.

### BRIEF DESCRIPTION OF THE DRAWINGS

The present invention will become more fully understood from the detailed description given hereinbelow and the appended drawings which given by way of illustration only, and thus are not intended as a definition of the limits of the present invention, and wherein:

FIG. 1 is a block diagram showing a broadcast signal receiving system of the present invention;

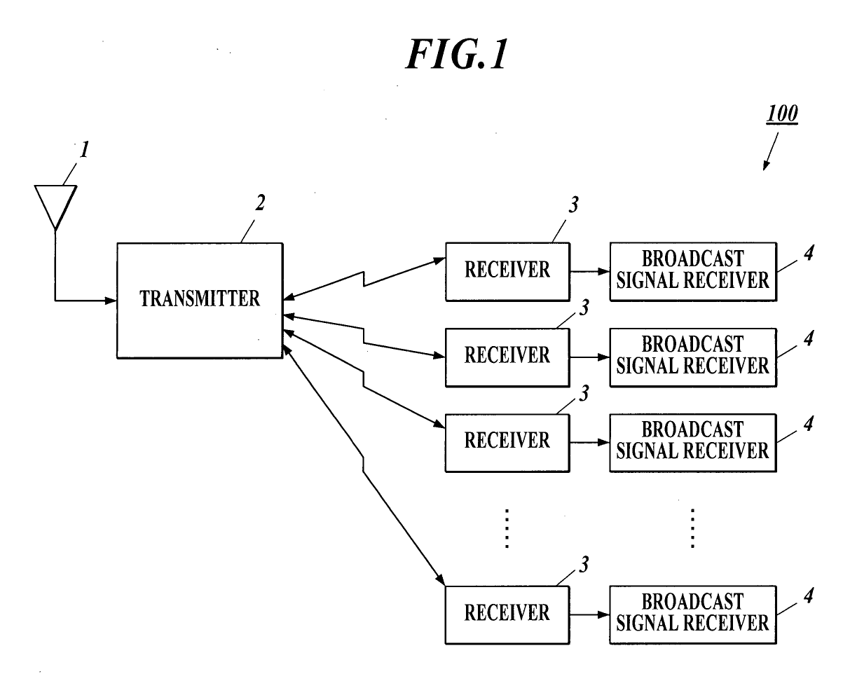

FIG. 2 is a block diagram showing an internal structure of the broadcast signal receiving system of the invention;

FIG. 3 is a block diagram showing an internal structure of a transmitter of the invention; and

FIG. 4 is a flowchart used for explaining a broadcast signal receiving operation of the broadcast signal receiving system of the invention.

### DETAILED DESCRIPTION OF THE INVENTION

The best mode for executing the broadcast signal receiving system of the present invention will be explained in detail.

First, a structure of the broadcast signal receiving system 100 of the invention will be explained with reference to the drawings.

The broadcast signal receiving system 100 of the invention includes an antenna 1, a transmitter 2 connected to the antenna 1, receivers 3 connected to the transmitter 2 in a wireless manner, and broadcast signal receivers 4 connected to the receivers 3.

The number of receivers 3 connected to the transmitter 2 is not limited.

The antenna 1 is a parabolic antenna or a UHF antenna, etc. The antenna 1 receives broadcast signals such as an FM broadcast, an AM broadcast, a ground digital broadcast, a BS/CS broadcast and a ground analogue broadcast, and outputs, to the transmitter 2, broadcast signals such as an FM signal, an AM signal, a ground digital signal, a BS/CS signal and a ground analogue signal. When a broadcast wave is to be received through a CATV line, a connection cable (not shown) may be provided.

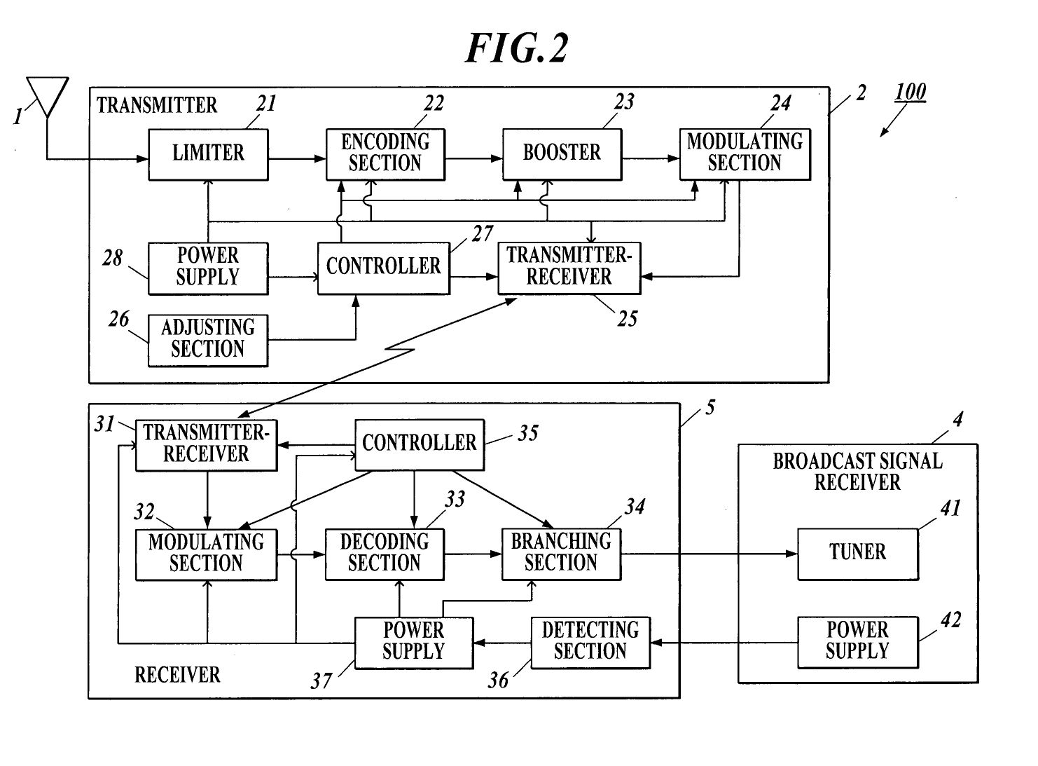

As shown in FIG. 2, for example, the transmitter 2 includes a limiter 21, an encoding section 22, a booster 23, a modulating section 24, a transmitter-receiver 25, an adjusting section 26, a controller 27 and a power supply 28.

The limiter 21, for example, prevents high voltage which is instantaneously output from the antenna 1 due to thunder or the like from being output to the transmitter 2.

The encoding section 22 encodes a broadcast signal which is output from the limiter 21, and outputs the same to the booster 23. With this, the encoding section 22 functions as encoding member.

The booster 23 amplifies amplitude of a broadcast signal which is output from the encoding section 22, thereby amplifying the broadcast signal.

The modulating section 24 includes a modulating circuit. The modulating section 24 modulates a wavelength of a broadcast signal which is output from the booster 23 into cm waveband. More specifically, the modulating section 24 modulates a broadcast signal which is output from the booster 23 into a broadcast signal of 5 to 8 GHz. With this, the modulating section 24 functions as a portion of the modulating member.

The transmitter-receiver 25 executes communication between the transmitter 2 and the receiver 3, for example, by a wireless communication. For example, the transmitter-receiver 25 sends a broadcast signal which is output from the modulating section 24 to the receiver 3. With this, the transmitter-receiver 25 functions as sending section.

The adjusting section 26 includes various keys (not shown) etc., for setting wavelength of a broadcast signal modulated in the modulating section 24 within cm waveband. If the various keys are operated by a user, a set value of the wavelength of a broadcast signal modulated in the modulating section 24 is output to the controller 27. More specifically, the adjusting section 26, for example, includes keys for setting a width of a range within which the transmitter 2 sends a broadcast signal. If the keys are operated, a set value of width is output to the controller 27, and the controller 27 controls the modulating section 24 such that the wavelength of the broadcast signal is modulated into a wavelength corresponding to the set value. With this, the adjusting section 26 functions as adjusting member.

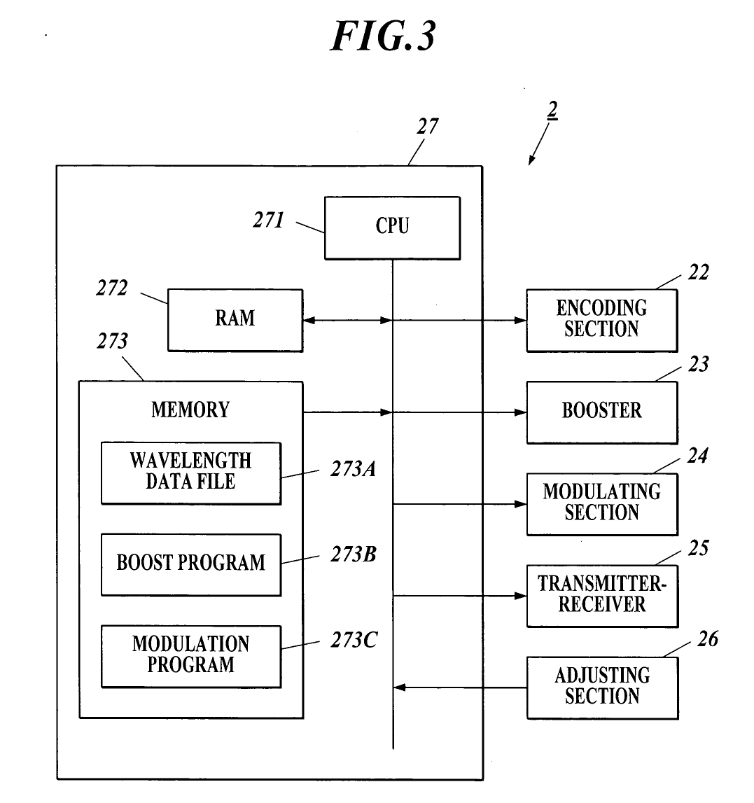

The controller 27, for example, as shown in FIG. 3, includes a CPU (Central Processing Unit) 271, a RAM (Random Access Memory) 272 and a memory 273. The controller 27 is connected to the encoding section 22, the booster 23, the modulating section 24, the transmitter-receiver 25 and the adjusting section 26 etc., and controls these elements, thereby controlling the entire transmitter 2.

The CPU 271 reads out processing program stored in the memory 273, develops the program in the RAM 272, executes the same, and controls the entire transmitter 2.

The RAM 272 develops the processing program which is executed by the CPU 271 in a program storing region in the RAM 272, and stores, in a data storing region, input data and a processing result and the like generated when the processing program is executed.

The memory 273 includes a storing medium (not shown) in which a program, data and the like are previously stored. This storing medium, for example, comprises a semiconductor memory. The memory 273 stores therein various data sets of the CPU 271 for realizing a function for controlling the entire transmitter 2, various processing programs, and data processed by executing these programs. More specifically, for example, a wavelength data file 273A, a boost program 273B, and a modulating memory 273C are stored in the memory 273 as shown in FIG. 3.

Stored in the wavelength data file 273A is, for example, data in which a width of a range within which the transmitter 2 sends a broadcast signal, and a wavelength of the broadcast signal required for sending the broadcast signal within the width range are associated with each other.

The boost program 273B is, for example, a program for realizing function which allows the CPU 271 to control the booster 23 to detect the magnitude of the amplitude of the broadcast signal which is output from the encoding section 22, and to amplitude the magnitude of the amplitude of the broadcast signal such that the detected magnitude becomes a predetermined magnitude.

The modulation program 273C is, for example, a program for realizing functions to allow the CPU 271 to control the modulating section 24 to modulate the wavelength of the broadcast signal which is output from the booster 23 such that the wavelength becomes a set value which is input from the adjusting section 26. More specifically, the modulation program 273C, for example, refers the wavelength data file 273A to extract a wavelength corresponding to the set value based on the set value of width to which the broadcast signal input from the adjusting section 26 is sent, controls the modulating section 24 to modulates the wavelength of the broadcast signal output from the booster 23 so that it becomes the extracted wavelength, controls the transmitter-receiver 25 to send a wavelength width varied in the modulation processing to the receiver 3. The CPU 271 executes the modulation program 273C, and functions as a portion of the modulating member.

The power supply 28 is, for example, connected to the limiter 21, the encoding section 22, the booster 23, the modulating section 24, the transmitter-receiver 25 and the controller 27. When the power supply 28 is turned ON, the limiter 21, the encoding section 22, the booster 23, the modulating section 24, the transmitter-receiver 25 and the controller 27 are turned ON. When a domestic power supply outlet (not shown) is connected to the power supply 28, the power supply 28 is turned ON.

As shown in FIG. 2, for example, the receiver 3 includes a transmitter-receiver 31, a modulating section 32, a decoding section 33, a branching section 34, a controller 35, a detecting section 36 and a power supply 37.

The transmitter-receiver 31, for example, executes communication between the receiver 3 and the transmitter 2 by the wireless communication. For example, the transmitter-receiver 31 receives a broadcast signal sent from the transmitter 2, and outputs the same to the modulating section 32. With this, the transmitter-receiver 31 functions as a receiving section.

The modulating section 32, for example, includes a modulating circuit and the like. The modulating section 32 modulates a broadcast signal which is output from the transmitter-receiver 31, and outputs the same to the decoding section 33. More specifically, the modulating section 32 modulates a broadcast signal in accordance with a wavelength width varied in the modulating processing by the modulating section 24 of the transmitter 2. With this, the modulating section 32 functions as the demodulating member.

The decoding section 33, for example, decodes a broadcast signal which is output from the modulating section 32, and outputs the same to the branching section 34. With this, the decoding section 33 functions as the decoding member.

The branching section 34, for example, branches a broadcast signal which is output to the broadcast signal receiver 4 from a broadcast signal which is output from the decoding section 33, and outputs the same to the broadcast signal receiver 4. More specifically, the branching section 34 branches a broadcast signal which is output from the decoding section 33 into an FM signal, an AM signal, a ground digital signal, a BS/CS signal, a ground analogue signal and the like, and selects a broadcast signal to be output to the broadcast signal receiver 4 connected to the receiver 3 from the an FM signal, the AM signal, the ground digital signal, the BS/CS signal, the ground analogue signal and the like, and outputs the same to the broadcast signal receiver 4. With this, the branching section 34 functions as the branching member.

The controller 35 is, for example, connected to the transmitter-receiver 31, the modulating section 32, the decoding section 33 and the branching section 34, controls these elements, thereby controlling the entire receivers 3.

The detecting section 36 is, for example, connected to a power supply 42 (later described) of the broadcast signal receiver 4 and the power supply 37 of the receiver 3. When the detecting section 36 detects that the power supply 42 of the broadcast signal receiver 4 is turned ON, the detecting section 36 turns the power supply 37 of the receiver 3 ON.

The power supply 37 is, for example, connected to the transmitter-receiver 31, the modulating section 32, the decoding section 33, the branching section 34 and the controller 35. When the power supply 37 is turned ON, the transmitter-receiver 31, the modulating section 32, the decoding section 33, the branching section 34 and the controller 35 are turned ON. The turning ON/OFF operation of the power supply 37 is controlled by the detecting section 36.

The broadcast signal receiver 4, for example, includes a tuner 41, the power supply 42, and the like. A broadcast signal is output from the receiver 3 to the tuner 41, and a broadcast signal desired by a user is selected by the tuner 41. The power supply 42 is turned ON when it is connected to a domestic power supply outlet (not shown).

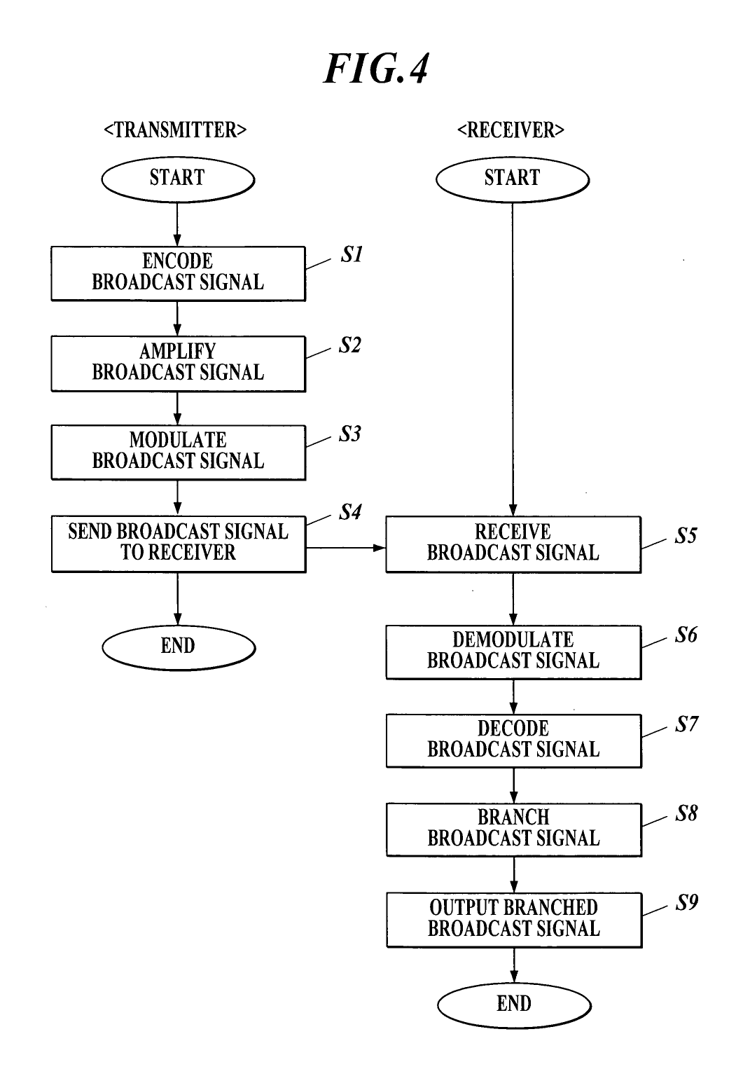

Next, a reception operation of the broadcast signal of the broadcast signal receiving system 100 having such a structure will be explained with reference to a flowchart shown in FIG. 4.

First, a broadcast signal is output from the antenna 1 to the encoding section 22 through a limiter 21, the broadcast signal is encoded by the encoding section 22, and is output to the booster 23 (step Si). Next, the CPU 271 executes the boost program 273B so that the broadcast signal is amplified in the booster 23 and is output to the modulating section 24 (step S2). Next, the CPU 271 executes the modulation program 273C and with this, a broadcast signal is modulated such that the wavelength of the broadcast signal becomes equal to a set value which is set in the adjusting section 26 in the modulating section 24, and it is output to the t24 (step S3) Then, the broadcast signal is sent to the receiver by the transmitter-receiver 25 (step S4), the broadcast signal is received by the transmitter-receiver 31, and it is output to the modulating section 32 (step S5). Next, the broadcast signal is modulated in the modulating section 32 (step S6), and it is output to the decoding section 33 (step S7). Then, the broadcast signal is decoded in the decoding section 33, and it is output to the branching section 34 (step S8). Next, the broadcast signal is branched in the branching section 34, and it is output to the broadcast signal receiver 4 (step S9).

According to the broadcast signal receiving system 100 of the present invention as explained above, in the transmitter 2, a broadcast signal output from the antenna 1 is encoded by the encoding section 22, the CPU 271 executes the modulation program 273C so that a wavelength of the broadcast signal encoded by the modulating section 24 is modulated into cm waveband, the modulated broadcast signal is sent to the receiver 3 by the transmitter-receiver 25 in the wireless manner, the broadcast signal sent from the transmitter 2 by the transmitter-receiver 31 is received by the receiver 3, the broadcast signal is demodulated by the modulating section 32, and the demodulated broadcast signal is decoded by the decoding section 33. Therefore, since the broadcast signal sent from the transmitter 2 is modulated into the cm waveband, it is possible to prevent the broadcast signal from leaking to an adjoining house such as a stand-alone house or condominium, and the broadcast signal modulated into the cm waveband can be sent to each receiver 3 without being blocked by a wall or the like. Thus, it is possible to prevent a broadcast signal from leaking outside of a house, and to reliably send a broadcast signal to a device in each room.

Since a broadcast signal is sent from the transmitter 2 to the receiver 3 in the wireless manner, it is unnecessary to connect the antenna terminal and each device through a cable, and a broadcast signal can easily be sent to a device in each room in the wireless manner.

A broadcast signal decoded by the decoding section 33 is branched by the branching section 34 and is output to the broadcast signal receiver 4. Therefore, even if a broadcast signal sent from the transmitter is mixed with an FM signal, an AM signal, a ground digital signal, a BS/CS signal, a ground analogue signal or the like, the broadcast signal can be branched into a broadcast signal necessary for each broadcast signal receiver 4.

Since the modulating section 24 modulates a broadcast signal encoded by the encoding section 22 into a wavelength which is set by the adjusting section 26, it is possible to set a wavelength of a broadcast signal to be modulated in accordance with a sending range of the broadcast signal by the adjusting section 26, it is possible to prevent a broadcast signal from leaking outside of a house more reliably, and a broadcast signal can be sent to a device in each room more reliably.

The receiver 3 may inform the transmitter 2 of the fact that the power supply 37 of the receiver 3 is turned ON, and if the transmitter 2 is informed, the power supply 28 of the transmitter 2 may be turned ON.

The communication between the transmitter 2 and the receiver 3 may be executed using a Lightwave of near-infrared radiation.

The entire disclosure of Japanese Patent Application No. 2006-012088 filed on Jan. 20, 2006, including description, claims, drawings and summary are incorporated herein by reference in its entirety.

What is claimed is:

1. A broadcast signal receiving system comprising an antenna, a transmitter connected to the antenna, a receiver connected to the transmitter in a wireless manner, and a broadcast signal receiver connected to the receiver, wherein
the transmitter comprises
encoding member to encode a broadcast signal which is output from the antenna,
modulating member to modulate a wavelength of the broadcast signal encoded by the encoding member, into cm waveband,
an adjusting member to set the wavelength of the broadcast signal modulated by the modulating member within the cm waveband, and
a sending section for sending the broadcast signal modulated by the modulating member to the receiver in the wireless manner,
the receiver comprises
a receiving section for receiving a broadcast signal sent from the transmitter,
demodulating member to modulate a broadcast signal received by the receiving section,
decoding member to decode a broadcast signal demodulated by the demodulating member, and
branching member to branch a broadcast signal decoded by the decoding member and to output the same to the broadcast signal receiver,
the modulating member modulates a broadcast signal which is encoded by the encoding member into a wavelength which is set by the adjusting member.

2. A broadcast signal receiving system comprising an antenna, a-transmitter connected to the antenna, and a receiver connected to the transmitter in a wireless manner, wherein
the transmitter comprises
encoding member to encode a broadcast signal which is output from the antenna,.
modulating member to modulate a wavelength of the broadcast signal encoded by the encoding member, into cm waveband, and
a sending section for sending the broadcast signal modulated by the modulating member to the receiver in the wireless manner,
the receiver comprises
a receiving section for receiving a broadcast signal sent from the transmitter,
demodulating member to modulate a broadcast signal received by the receiving section, and
decoding member to decode a broadcast signal demodulated by the demodulating member.

3. The broadcast signal receiving system of claim 2, wherein
the transmitter comprises an adjusting member to set the wavelength of the broadcast signal modulated by the modulating member within the cm waveband, and
the modulating member modulates a broadcast signal which is encoded by the encoding member into a wavelength which is set by the adjusting member.
